(19) United States
(12) Patent Application Publication
(10) Pub. No.: US 2006/0190261 A1
(43) Pub. Date: Aug. 24, 2006

(54) Method and device of speech recognition and language-understanding analyis and nature-language dialogue system using the same

(76) Inventor: Jui-Chang Wang, Taipei City (TW)

Correspondence Address: J.C. Patents, Inc., Suite 250, 4 Venture, Irvine, CA, 92618, US

(21) Appl. No.: 11/270,191

(22) Filed: Nov. 8, 2005

(30) Foreign Application Priority Data
Feb. 21, 2005 (TW) 94104985

(51) Int. Cl. G10L 13/08

(52) U.S. Cl. 704/260

(57) ABSTRACT

A method of speech recognition and language-understanding analysis is provided. According to a segmental word-concept-tag compound N-gram model, an input speech is divided into a plurality of segmental phrases. Each segmental phrase is attached a tag to indicate whether said segmental phrase is a meaningful segmental phrase or a meaningless segmental phrase. The meaningless segmental phrases are deleted, and only the meaningful segmental phrases are reserved. The language-understanding analysis is carried out to the meaningful segmental phrases according to segmental sub-grammars.

### CROSS-REFERENCE TO RELATED APPLICATION

This application claims the priority benefit of Taiwan application serial no. 94104985, filed on Feb. 21, 2005. All disclosure of the Taiwan application is incorporated herein by reference.

### BACKGROUND OF THE INVENTION

1. Field of the Invention

This invention generally relates to a method and system of speech recognition, and especially to a method and system of using natural language dialogue recognition.

2. Description of Related Art

The dialogue system using an input speech has become gradually popular. The user only needs to utter his/her requirement (for example, checking a train schedule, a flight schedule, a show program, etc.) to a system such as a telephone speech system, the system will find out the answer according to the input speech of the user. Further, the answer will be advised to the user with a speech manner.

For example, when the user utilizes a speech dialogue system and, with oral manner, inputs “the flight schedule information of a certain year certain month certain date certain time, from place A to place B”, the dialogue system can integrate the necessary information from the input sentence for the user. For example, the dialogue system can output information “the available flight schedule for the certain year certain month certain date certain time, from place A to place B is . . . ” to the user. Along with the increasing demand, the sentences which the user inputs have become relatively complicated, and the system is required to more accurately integrate and output the necessary output speech information from the input speech sentences to the user. Therefore, how to recognize the user's input speech is a very important subject.

FIG. 1 is a drawing schematically showing a view of a conventional natural language dialogue system. The system comprises a speech recognition engine 12 and a language understanding analyzer 14, which are respectively positioned at a front end of a dialogue management system 16. The output of the speech recognition engine 12 is provided to the language understanding analyzer 14 as an input to perform a language analysis. After the analysis, the recognition result of the language understanding analyzer 14 is used as a reference for the final dialogue management.

The present speech recognition engine utilizes the pattern recognition technology, in general, such as the Hidden Markov Model (HMM), the segmental probability model and the neural network technology, etc. The short period characteristic of the input sentence is selected as parameter strings, the output can be one or plural possible word strings; sometimes outputs a word graph or a word lattice. Generally, the output word string or word lattice only indicates words without other marks.

A general “language understanding analyzer” utilizes a top-down, a bottom-up or a mixing grammar parser to interpret the word string or word lattice output from “the speech recognition engine” and to generate a sentence with grammatical structure or semantic knowledge according to the pre-written grammar rules. The accuracy and success rate of the interpretation depends on the quality of the parser and the grammar rules. Generally, for the purpose of narrow-domain language understanding usable grammar rules can be easily written. On the other hand, the grammar rules of the wide domain language understanding are often imprecise and errors may be likely overlooked. Restriction to exceptional professionals and time constraints of expertise cultivation, it is extremely difficult and time-consuming to develop such natural language dialogue system.

Therefore, from the above mentioned problem it can be understood that, in order to solve the problem effectively, it is urgent and important to develop a new segmental word-concept-tag model as an interface and a node of “the speech recognition engine” and “the language understanding parser”.

### SUMMARY OF THE INVENTION

An object of the present invention is to provide a method and device of speech recognition and language understanding analysis, wherein a segmental word-concept-tag model is utilized for effectively increasing the speech recognition efficiency and the correctness.

Another object of the present invention is to provide a natural language dialogue system, wherein the above mentioned method and device of speech recognition and language understanding analysis are utilized, with the segmental word-concept-tag model to effectively increase the speech recognition efficiency and the correctness, so that the system can perform dialogues with the user in a manner closer to the natural dialogue.

In order to achieve the above mentioned objects and other objects, the present invention provides a method of speech recognition and language understanding analysis, comprising steps of receiving an input speech; dividing the input speech into a plurality of segmental phrases according to a segmental word-concept-tag compound N-gram model; and analyzing the segmental phrases according to segmental sub-grammars.

Before analyzing the segmental phrases, each segmental phrase can be further divided to meaningful segmental phrases or meaningless segmental phrases. The meaningless segmental phrases in the segmental phrases are deleted. Further, each meaningful segmental phrase and meaningless segmental phrase can be attached with a tag.

The present invention further provides a device of speech recognition and language understanding analysis. The device comprises a speech recognition module for receiving an input speech, in which the input speech is divided into a plurality of segmental phrases according to a segmental word-concept-tag compound N-gram model; and a language understanding analysis module for analyzing the segmental phrases according to segmental sub-grammars.

In the above mentioned device, each segmental phrase is further divided into the meaningful segmental phrases or the meaningless segmental phrases by the speech recognition module. The meaningless segmental phrases in the segmental phrases are deleted by the speech understanding analysis module. Further, in each segmental phrase, the meaningful segmental phrase or the meaningless segmental phrase is distinguished by the speech recognition module by attaching with a tag thereon.

The present invention further provides a natural language dialogue system with better performance. The natural language dialogue system comprises a speech recognition module, a language speech understanding analysis module and a dialogue management module. The speech recognition module receives an input speech, and divides the input speech into a plurality of segmental phrases according to a segmental word-concept-tag compound N-gram model. The language understanding analysis module analyzes the segmental phrases according to segmental sub-grammars. The dialogue management module selects a corresponding dialogue output from a database according to the output of the speech understanding analysis module. The speech synthesizing module synthesizes the output of the dialogue management module into a speech output signal.

### BRIEF DESCRIPTION OF THE DRAWINGS

While the specification concludes with claims particularly pointing out and distinctly claiming the subject matter which is regarded as the invention, the objects and features of the invention and further objects, features and advantages thereof will be better understood from the following description taken in connection with the accompanying drawings.

FIG. 1 is a drawing schematically showing a view of a conventional natural language dialogue system.

FIG. 2 is a drawing schematically showing a view of a natural language dialogue system according to an embodiment of the present invention.

FIG. 3 is a drawing schematically showing a conceptual view of a segmental word-concept-tag compound N-gram model.

FIG. 4 is a drawing schematically showing a conceptual view of a language understanding analysis with segmental sub-grammars.

### DESCRIPTION OF THE PREFERRED EMBODIMENTS

First, “speech recognition” and “language understanding” have been viewed as two independent mechanisms functioning separately. They are researched and developed distinctively by experts of digital signal process and the language calculation process. As the result of diametrical development, the semantic concept only exists in the language model without any connection with the speech recognition function. Nevertheless, people naturally use the two skills closely and interactively at the same time for developing automatic spoken dialogue systems. The segmental word-concept-tag model intermediary algorithm is studied and developed for solving the problem. Thus, the recognition and understanding functions of the natural language dialogue system and the efficiency of the system development can be improved. Such concept is the essence of the present invention.

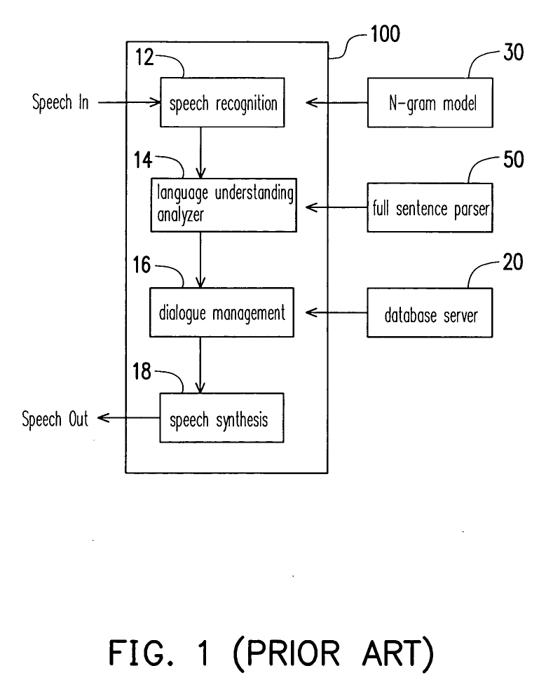

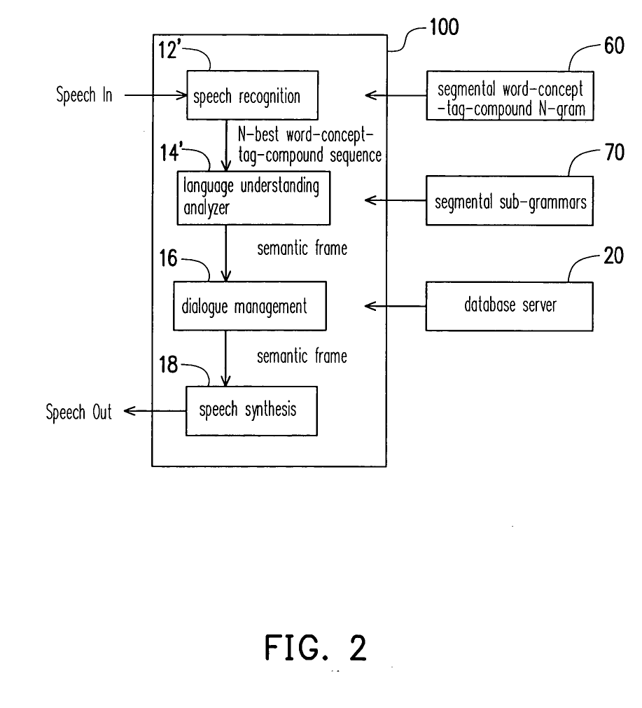

FIG. 2 is a drawing schematically showing a view of a natural language dialogue system according to an embodiment of the present invention, wherein the elements with the same or similar functions with FIG. 1 are indicated with the same references. Further, the present invention emphasizes on how to use the segmental phrases for performing speech analysis and recognition. That is, the two steps of the speech recognition 12′ and the language understanding analysis 14′.

As shown in FIG. 2, the natural language dialogue system 100 comprises a speech recognition module 12′, a speech understanding analyzer 14′, a dialogue management module 16, a speech synthesizing module 18 and a database 20. When a speech is input into the speech recognition module 12′, the speech recognition module 12′ recognizes the input speech by utilizing a segmental word-concept-tag compound N-gram model, and further transmits the result of N-best word-concept-tag compound sequence to the language understanding analyzer 14′. The language understanding analyzer 14′ performs a language-understanding analysis according to a segmental sub-grammar model 70, and outputs a semantic frame to the dialogue management module 16.

The dialogue management module 16 searches data in the database 20 according to the inputted semantic frame; transmits the searching result to the speech synthesizing module 18 for speech synthesis. Further, the compounded speech is outputted. Hence, a suitable answer to the question can be found and outputted to the user with a speech manner, so that the object of the natural language dialogue is achieved. The later stage comprises the dialogue management module 16, the speech synthesizing module 18 and the database 20, which adopt the conventional technology and is not repeatedly described and explained. The following description will be concentrated on the speech recognition module 12′ and the speech understanding analyzer 14′ at the front stage.

The present invention utilizes a “segmental word-concept-tag compound N-gram model” 60 as the intermediary hinge of the speech recognition and the language understanding analysis. The segmental word-concept-tag compound N-gram model 60 utilizes the compound N-gram model statistic rule which is widely used in the large vocabulary continuous speech recognition (i.e. LVCSR). Using sub-sentence as a unit, the segmental word-concept-tag compound N-gram model 60 is trained according to a lexicon which collects and accumulates words or phrases from every possible application system, and is inserted into a language model of the speech recognition step. The segmental word-concept-tag compound N-gram model replaces the un-segmental compound N-gram model in the conventional natural language dialogue system, and outputs a segmental sentence translation.

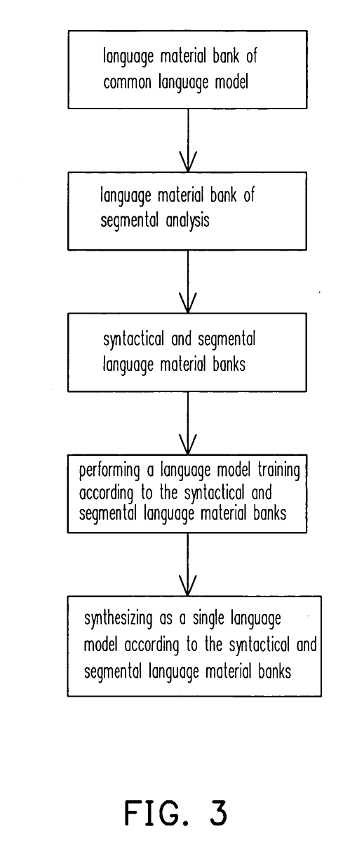

“The segmental word-concept-tag compound N-gram model” 60 can be described in more detail as follows. FIG. 3 is a drawing schematically showing a conceptual view of “a segmental word-concept-tag compound N-gram model 60”. As shown in FIG. 3, “the segmental word-concept-tag compound N-gram model 60” is further divided into “a language material bank of common language model”, “a language material bank of segmental analysis”, “a syntactical and segmental language material banks” and “performing a language model training according to the syntactical and segmental language material banks and finally synthesizing as a single language model”.

A sentence in the language material bank of common language model is, for example, as follows:

I would like to take a flight on October 30 from Taipei to Moscow.

After the manual sentence analysis, which means to perform “the segment analysis”, the result is as follows:

Sentence pattern: I would like to take a flight <time><route>.

The above mentioned sentence comprises two so called <time> phrase and <route> phrase. Wherein, the <time> phrase is “on October 30”, and the <route> phrase is “from Taipei to Moscow”.

In “the language material bank segmental analysis” and “the syntactical and segmental language material banks” shown in FIG. 3, multiple “syntactical material banks” and multiple “phrasal phrase material banks” are established for selection, such as the following examples:

The examples of “the syntactical material banks” are as follows:

I would like to take a flight <time><route>.

I need an airflight ticket <time><route>.

Please give me an airflight ticket <time><route>.

Help me to get a flight <route>.

<Time><route>.

<Route>.

The examples of “<Time> phrasal material banks” are as follows:

On October 30

September 3

Next Monday
The second Sunday in May
three o'clock, tomorrow afternoon

The examples of “<route> phrasal material banks” are as follows:

From Taipei to Moscow

Go to New York

From Taipei via Bangkok to London

Transfer at Hong Kong to Shanghai

Depart from Kaohsiung.

Further, a language model training is performed according to the syntactical language material banks and the segmental language material banks; and a single sentence model is merged at last. One of the manners is as follows:

the syntactical language material banks→perform a common language model training→the language model of the sentence structure;

the segmental language material banks→perform a common language model training→the language model of the segmental language material banks. Further, the above mentioned language models are merged into to a single language model which is the segmental word-concept-tag compound N-gram model.

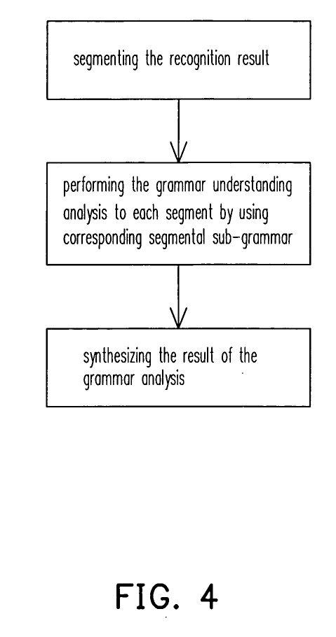

With reference of FIG. 4, the language understanding analysis of the segmental sub-grammar in FIG. 2 is described as follows. The segmental sub-grammar comprises “segmenting the recognition result”, “performing the grammar understanding analysis to each segment by the corresponding segmental sub-grammar” and “synthesizing the result of the grammar analysis”.

First, regarding to segmenting the recognition result, with the above mentioned sentence as an example, the recognition result marks two phrases <time> and <route>.

The sentence: I would like to take a flight <time/> on October 30</time><route/> from Taipei to Moscow </route>.

The sentence is automatically divided into the following phrases:

Sentence pattern: I would like to take a flight <time><route>.

Wherein the phrases are as follows:

<time> phrase: on October 30

<route> phrase: from Taipei to Moscow.

Further, the grammar understanding analysis is performed to each segment by the corresponding segmental sub-grammar. With the above mentioned sentence as an example, the language understanding analysis is performed separately to the sentence structure, <time> phrase and <route> phrase.

The above mentioned sentence structure is “I would like to take a flight <time><route>”, a concept of “inquire the flight schedule at certain time and certain route” is obtained by utilizing the syntactical grammar understanding analysis.

The above mentioned <time> phrase is “on October 30”, the concept of <month=October> and the concept of <date=30> are achieved by utilizing <time> phrasal grammar understanding analysis.

The above mentioned <route> phrase is “from Taipei to Moscow”, the concept of <departure place=Taipei> and the concept of <arrival place=Moscow> are achieved by utilizing <route> phrasal grammar understanding analysis.

Furthermore, the results of the grammar understanding analysis are combined. Still with the above mentioned segmental sub-grammar understanding analysis result as an example. The concepts, which are achieved from the above mentioned grammar understanding analysis, are as follows:

concept: <inquire the flight at certain time certain route>;

concept: <month=October> and <date=30>; and

concept: <departure place=Taipei> and <arrival place=Moscow>.

Besides, when a certain segment does not have an understanding analysis result, the understanding analysis results of the other segments being combined into will not be affected. For example, if <time> phrasal grammar understanding analysis for <time> phrase is not performed at the above mentioned sentence, the understanding and analysis result is as follows:

“I would like to take a flight <time><route>”, the concept of “inquire about the flight at certain time certain route” is achieved. By utilizing <route> phrasal grammar understanding and analysis to <route> phrase “from Taipei to Moscow”, the concept of <departure place=Taipei> and the concept of <arrival place=Moscow> are achieved.

By combining the above mentioned understanding analysis results, the result is achieved as follows:

concept <inquire about the flight at certain time certain route>;

concept <departure place=Taipei> and concept <arrival place=Moscow>.

In summary, in the segmental word-concept-tag compound N-gram model 60, the input speech is meaningfully segmented; the meaning of each segment is then recognized. For example, when a user inputs a speech “Please tell me the flight schedule from Taipei to Los Angeles on November 30”, the speech can be divided into several meaningful segments such as “on November 30”, “from Taipei to Los Angeles” and “flight schedule” etc. In other words, “a certain year certain month certain date” can be a segmental phrase, “from a certain place to another certain place”, “from a certain time to another certain time”, and “a certain time schedule” etc. Through the manner, the speech recognition can analyze the input speech information of the natural language dialogue system 100, select the meaningful segmental phrases and delete the unnecessary phrases.

From the dialogue habit, when an initial word appears, the probability of the following other words can be predicted. According to this concept, the object of selecting the segmental phrases can be achieved. In the above mentioned example, when the word “from” appears, it can be understood that the phrases which often appear can probably be “from a certain o'clock to a certain o'clock”, “from a certain place to a certain place”, etc, so that the speech recognition module 12′ can simplify the recognition process in corresponding to the segmental phrases. It means that if every segmental phrase is selected from input speech information, the object of recognition can be achieved. Furthermore, when performing with the segmental phrase manner, it is not necessary to perform a syntactical grammar analysis to a whole sentence, so that the errors can be decreased. The recognition accuracy is thus improved. For example, when a place name appears after “from”, the phrase of “from a certain place to a certain place” can be recognized, etc.

Furthermore, because there are often contained many unnecessary and meaningless words or phrases in a person's conversation, if syntactic analysis is applied to a whole sentence, the analysis may not be able to carry out or the result may be erroneous. Therefore, in according to the present invention, the output of the speech recognition module 12′ can further comprise words and tags marked for segmental phrases. With the concept of phrase segments, the semantic process ability of the speech recognition is increased and the complex extent of the language understanding process is simplified. The stringent grammar requirement is decreased, therefore the efficiency and effect of developing the natural language dialogue system is increased.

Take the Chinese syntax as an example. In general, the syntactical structure is relatively loose (compared with English), adding words or missing words are occurred frequently. That is why adoption of enumerative scheme in Chinese grammatical rules is very difficult; and the success ratio of the dialogue system is therefore decreased. In other words, it is impossible to increase the success ratio for every particular case by adding a correspondent lexicon. Even each situation is considered, it will cause an over-expansion and an overload to the database or to the whole dialogue system.

The output word strings of the speech recognition in the present invention comprise the semantically significant words (tag 1) and the semantically non-significant words (tag 0). The former, for example, are: from, to, Taipei, . . . , etc. The latter, for example, are: hmm, what I mean is . . . , etc. The language understanding analyzer only processes with the semantically significant words and ignores the semantically non-significant words. Because the grammar rule does not process the semantically non-significant words, the compilation of grammar rules is therefore reduced greatly, and the total quantity of the possible phrasal combinations for recognition process is also reduced.

In other words, when the speech is inputted to the speech recognition module 12′, besides that the each segmental phrase is selected from the input speech information corresponding to the segmental word-concept-tag compound N-gram model 60, a tag is added to each of the segmental phrases to indicate whether the segmental phrase is meaningful or meaningless. Therefore, when the language understanding analysis module 14′ receives the output result from the speech recognition module 12′, the meaningless phrases will be deleted according to the tags and the meaningful phrases will be reserved. At the same time, the language understanding analysis module 14′ will only perform the language understanding analysis to the meaningful segmental phrases. Meanwhile, the language understanding analysis module 14′ will perform the language understanding analysis according to the segment sub-grammar 70. The conventional syntactic analysis to a whole sentence will not be performed. Obviously, the understanding analysis work of the language understanding analysis module 14′ is simplified greatly. Because the speech recognition module 12′ has selected the meaningful segment phrases according to the segmental word-concept-tag compound N-gram model 60, the language understanding analysis module 14′ will only process with the meaningful phrases; therefore the accuracy is substantially improved.

As the above mentioned, the segmental word-concept-tag of the speech recognition output naturally provides the segmental process ability to the language understanding process. Since the language understanding of the segmental process is not required to process with the precisely syntactic rules, the complicated design of the dialogue system can be simplified. Accordingly, the requirement of the memory capacity is decreased and the processing speed is increased. Further, the tagged phrases outputted from the speech recognition facilitate the syntactic analysis.

In the segmental word-concept-tag compound N-gram model of “speech recognition engine”, each segmental model attaches a lexicon which is collected by the words within the segment phrases. Without using the whole sentence as the range, the word collection is less related to the specific application. Therefore, the present invention may collect and accumulate lexicons from different applicable fields or be applied to various applicable fields for certain segmental phrase types. Through a long period of collection and accumulation, the coverage of phrases and related word frequencies can be increased. Thus, the recognition accuracy is increased.

In summary, not only the processing speed is increased, but also the entire efficiency of developing the natural language dialogue system is further increased.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

What is claimed is:

1. A method of speech recognition and language understanding analysis, comprising:
receiving an input speech;
dividing input speech into a plurality of segmental phrases according to a segmental word-concept-tag compound N-gram model, the is divided; and
analyzing the segmental phrases according to segmental sub-grammars.

2. The method of claim 1, further comprising before performing the segmental phrase analysis:
dividing each segmental phrase into meaningful segmental phrases or meaningless segmental phrases; and
deleting the meaningless segmental phrases in the segmental phrases.

3. The method of claim 1, wherein the segmental word-concept-tag compound N-gram model further comprise steps of:
analyzing a sentence structure of the input speech from a language material bank of a common language model;
performing a language material bank segmental understanding analysis for the sentence structure of the input speech to obtain the meaning of the segmental phrases; and
utilizing a syntactical and segmental language material bank to perform a language model training according to the segmental phrases, and then further merging to a single language model.

4. The method of claim 2, wherein the meaningful segmental phrase or the meaningless segmental phrase is marked with a tag.

5. A speech recognition method, characterized in that a received input speech is divided into a plurality of segmental phrases according to a segmental word-concept-tag compound N-gram model.

6. The speech recognition method of claim 5, wherein the segmental word-concept-tag compound N-gram model further comprises steps of:
analyzing a sentence structure of the input speech from a language material bank of a common language model;
performing a language material bank segmental understanding analysis for the sentence structure of the input speech to obtain the meaning of the segmental phrases; and
utilizing a syntactical and segmental material bank to perform a language model training according to the segmental phrases, and then further merging to a single language model.

7. A device of speech recognition and language understanding analysis, comprising:
a speech recognition module, for receiving an input speech and dividing the input speech into a plurality of segmental phrases according to a segmental word-concept-tag compound N-gram model; and
a speech understanding analysis module, for analyzing the segmental phrases according to segmental sub-grammars.

8. The device of claim 7, wherein the speech recognition module further divides each segmental phrase into meaningful segmental phrases or meaningless segmental phrases, and the speech understanding analysis module deletes the meaningless segmental phrases in the segmental phrases.

9. The device of claim 8, wherein the meaningful segmental phrase or the meaningless segmental phrase is distinguished by attaching a tag thereto.

10. A natural language dialogue system, comprising:
a speech recognition module, for receiving an input speech, wherein the input speech is divided into a plurality of segmental phrases according to a segmental word-concept-tag compound N-gram model;
a language understanding analysis module, for analyzing the segmental phrases according to segmental sub-grammars;
a dialogue management module, for selecting a corresponding dialogue output from a database according to the output of the language understanding analysis module; and
a speech synthesizing module, for synthesizing the output of the dialogue management module to a speech output signal.

11. The natural language dialogue system of claim 10, wherein the speech recognition module further divides each segmental phrase into meaningful segmental phrases or meaningless segmental phrases, and the speech understanding analysis module deletes the meaningless segmental phrases in the segmental phrases.

12. The natural language dialogue system of claim 10, wherein the meaningful segmental phrase or the meaningless segmental phrase is distinguished by with adding a tag.
